(19) United States
(12) Patent Application Publication
(10) Pub. No.: US 2026/0363349 A1
(43) Pub. Date: Nov. 19, 2026

(54) AEROSOL GENERATING DEVICE

(71) Applicant: SHENZHEN SMOORE TECHNOLOGY LIMITED, Shenzhen (CN)

(72) Inventor: Zhijun CHEN, Shenzhen (CN)

(73) Assignee: SHENZHEN SMOORE TECHNOLOGY LIMITED, Shenzhen (CN)

(21) Appl. No.: 19/723,161

(22) Filed: Jun. 29, 2026

Related U.S. Application Data
(63) Continuation of application No. PCT/CN2024/130478, filed on Nov. 7, 2024.

(30) Foreign Application Priority Data
Dec. 9, 2023 (CN) 202311868775.6

(51) Int. Cl. A24F 40/57; A24F 40/46; A24F 40/53; H05B 6/80

(52) U.S. Cl. CPC A24F 40/57; A24F 40/46; A24F 40/53; H05B 6/802

(57) ABSTRACT

An aerosol generating device is provided. The aerosol generating device includes a microwave generation assembly, a microwave feed assembly, a microwave heating assembly, and a control assembly. The microwave generation assembly includes a protection circuit. The control assembly is configured to determine a current state and output a state control signal. The state control signal includes an operation control signal and a standby control signal. The protection circuit includes a detection module to detect the state control signal and output a switch control signal according to the state control signal, and a switch module. A second terminal of the switch module is connected to a power supply terminal of the power amplifier, and a constant-voltage signal is inputted via a control terminal of the power amplifier. A switch control module is configured to control switch-on and switch-off of the switch module according to the switch control signal.

### RELATED APPLICATION

The present application is a continuation of International Patent Application No. PCT/CN2024/130478, filed on Nov. 7, 2024, which claims priority to Chinese Patent Application No. 202311868775.6, filed on Dec. 29, 2023. The entire disclosure of the prior applications are hereby incorporated by reference.

### TECHNICAL FIELD

This disclosure relates to the field of electronics, and in particular, to an aerosol generating device.

### BACKGROUND

With the development of semiconductors, microwave power amplifiers have evolved from first-generation materials such as silicon and germanium, to second-generation materials such as gallium arsenide and gallium phosphide, and further to third-generation materials such as silicon carbide and gallium nitride, exhibiting increasingly diverse electrical performance. Moreover, microwave power amplifiers are widely used in various microwave electronic products, such as aerosol generating devices utilizing microwave heating. When in an operating or standby state, the power amplifier, as the primary heat-generating electronic component within the product, exhibits non-negligible power consumption. Particularly for a lithium battery-powered electronic product, such standby power consumption exerts a significant impact on the standby duration of the electronic product.

In some existing electronic products, the power amplifier is always-on, which inevitably increases the overall power consumption of the product. Another approach is to control the on/off state of the power amplifier using a switch circuit. Although this approach can reduce power consumption, component variations and load variations may induce fluctuations in control voltage (bias voltage), thereby degrading the electrical performance of the power amplifier. Moreover, frequent on-off switching may cause damage to the power amplifier.

### SUMMARY

An aerosol generating device, including a microwave generation assembly, a microwave feed assembly, a microwave heating assembly, and a control assembly. The microwave generation assembly generates a microwave signal, and the microwave feed assembly feeds the microwave signal into the microwave heating assembly, to heat an aerosol generating substrate. The microwave generation assembly includes a microwave signal source and a power amplifier that are connected to each other. The microwave generation assembly further includes a protection circuit configured to protect the power amplifier.

The control assembly is configured to determine a current state of the aerosol generating device, and output a state control signal. The state control signal includes an operation control signal and a standby control signal.

The protection circuit includes:
a detection module, configured to detect the state control signal, and output a switch control signal according to the state control signal;
a switch module, where a supply voltage signal is inputted via a first terminal of the switch module, a second terminal of the switch module is connected to a power supply terminal of the power amplifier, and a constant-voltage signal is inputted via a control terminal of the power amplifier; and
a switch control module, configured to control switch-on and switch-off of the switch module according to the switch control signal.

The detection module includes: a resistor R3, a resistor R5, and a diode D1. A first terminal of the resistor R5 serves as an input terminal of the detection module and is configured to input the state control signal. A second terminal of the resistor R5 is connected to a cathode of the diode D1 and a first terminal of the resistor R3. A second terminal of the resistor R3 is connected to a negative voltage. An anode of the diode D1 serves as an output terminal of the detection module and is configured to output the switch control signal.

The control terminal of the power amplifier is further connected to an output terminal of a negative voltage source, and the second terminal of the resistor R3 is connected to the control terminal of the power amplifier.

The detection module further includes a resistor R6. A first terminal of the resistor R6 is connected to the cathode of the diode D1, and a second terminal of the resistor R6 is connected to ground.

The switch module includes a metal-oxide-semiconductor (MOS) transistor Q1 and a resistor R1. A source of the MOS transistor Q1 serves as the first terminal of the switch module and is configured to input the supply voltage signal, and a drain of the MOS transistor Q1 serves as the second terminal of the switch module and is connected to the power supply terminal of the power amplifier. The resistor R1 is connected between the source and a gate of the MOS transistor Q1.

The switch control module includes a resistor R2, a resistor R4, a triode Q2, and a capacitor C1. A base of the triode Q2 is connected to ground via the resistor R4. An emitter of the triode Q2 is connected to an output terminal of the detection module, and a collector of the triode Q2 is connected to the gate of the MOS transistor Q1 via the resistor R2. The capacitor C1 is connected between the emitter of the triode Q2 and ground.

The aerosol generating device further includes:
an anti-reverse module, connected between the second terminal of the switch module and the power supply terminal of the power amplifier and configured to prevent backflow of a microwave signal outputted by the power amplifier.

The anti-reverse module includes a diode D2. An anode of the diode D2 is connected to the second terminal of the switch module, and a cathode of the diode D2 is connected to the power supply terminal of the power amplifier.

The microwave generation assembly further includes:
a coupler, configured to couple a partial microwave signal of a microwave signal outputted by the power amplifier; and
a detector, configured to detect an amplitude of the coupled microwave signal and transmit the amplitude to the control assembly.

The control assembly is configured to adjust, according to the amplitude, the power of the microwave signal outputted by the power amplifier.

The microwave generation assembly further includes a voltage management module.

The control assembly is configured to adjust, according to the amplitude, the power of the microwave signal outputted by the power amplifier by adjusting a supply voltage signal outputted by the voltage management module to the power amplifier.

The detection module detects the state control signal (the operation control signal or the standby control signal) outputted by the control assembly, and outputs the switch control signal according to the state control signal. The switch control module further controls switch-on and switch-off of the switch module according to the switch control signal, so that the power supply terminal of the power amplifier can selectively receive or not receive the supply voltage signal according to the state control signal of the aerosol generating device, and supplies power to the power amplifier only when the aerosol generating device is in an operating state and stops supplying power to the power amplifier when the aerosol generating device is in a standby state. In this way, power consumption of the power amplifier is reduced. Moreover, because the switch module is connected to the power supply terminal of the power amplifier, and the control terminal of the power amplifier is connected to the constant-voltage signal, even if component variations and load variations induce fluctuations in the switch control signal, the bias voltage of the power amplifier remains unchanged (constant voltage), and the electrical performance of the power amplifier is still not affected. In addition, the constant-voltage signal is inputted to the control terminal of the power amplifier, the power amplifier is not frequently switched on and off, thereby reducing the risk of damage.

### BRIEF DESCRIPTION OF THE DRAWINGS

In order to more clearly describe the examples of this disclosure, a brief introduction is given below to the drawings required for the description of the examples. Apparently, the drawings described below are only some examples of this disclosure, and a person of ordinary skill in the art may further derive other drawings from these drawings without creative effort. Among the drawings:

FIG. 1 is a logical structural diagram of Example 1 of an aerosol generating device of this disclosure.

FIG. 2 is a logical structural diagram of Example 1 of a power amplifier and a protection circuit shown in FIG. 1.

FIG. 3 is a circuit diagram of Example 2 of a power amplifier and a protection circuit shown in FIG. 1.

FIG. 4 is a logical structural diagram of Example 2 of an aerosol generating device of this disclosure.

FIG. 5 is a waveform diagram of signals in Case 1 of an aerosol generating device of this disclosure.

FIG. 6 is a waveform diagram of signals in Case 2 of an aerosol generating device of this disclosure.

### DETAILED DESCRIPTION

The following clearly and completely describes the technical solutions in the examples of this disclosure with reference to the drawings in the examples of this disclosure. Apparently, the described examples are some of rather than all of the examples of this disclosure. Other examples obtained by a person of ordinary skill in the art based on the examples in this disclosure without creative efforts shall fall within the scope of protection of this disclosure.

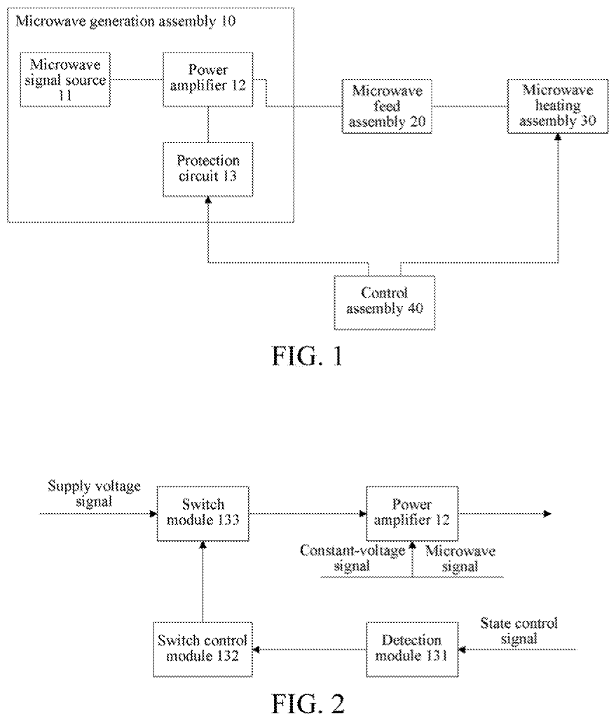

FIG. 1 is a logical structural diagram of Example 1 of an aerosol generating device of this disclosure. The aerosol generating device includes: a microwave generation assembly 10, a microwave feed assembly 20, a microwave heating assembly 30, and a control assembly 40. The microwave generation assembly 10 generates a microwave signal, and the microwave feed assembly 20 feeds the microwave signal to the microwave heating assembly 30, to heat an aerosol generating substrate. The microwave generation assembly 10 includes a microwave signal source 11 and a power amplifier 12 that are connected to each other, and further includes a protection circuit 13 connected to and configured to protect the power amplifier 12. The control assembly 40 is configured to determine a current state of the aerosol generating device, and output a state control signal. The state control signal includes an operation control signal and a standby control signal. The control assembly 40 outputs the operation control signal when the aerosol generating device heats the aerosol generating substrate, and outputs the standby control signal when the aerosol generating device is in a non-heating state or an abnormal state.

With reference to FIG. 2, the protection circuit 13 includes a detection module 131, a switch control module 132, and a switch module 133. A supply voltage signal is inputted via a first terminal of the switch module 133, a second terminal of the switch module 133 is connected to a power supply terminal of the power amplifier 12, and a constant-voltage signal is inputted via a control terminal of the power amplifier 12. In addition, the control terminal of the power amplifier 12 is further connected to an output terminal of the microwave signal source 11, that is the control terminal of the amplifier 12 is configured to input a microwave signal. In other words, a superimposed signal of a constant-voltage signal and a microwave signal (an alternating signal) is inputted via the control terminal of the power amplifier 12. The detection module 131 is configured to detect the state control signal, and output a switch control signal according to the state control signal. The switch control module 132 is configured to control switch-on and switch-off of the switch module 133 according to the switch control signal. Specifically, when the state control signal is the operation control signal, the switch module 133 is controlled to be switched on. In this case, the supply voltage signal may be inputted to the power supply terminal of the power amplifier 12, so that the power amplifier 12 operates normally. When the state control signal is the standby control signal, the switch module 133 is controlled to be switched off. In this case, the supply voltage signal is not inputted to the power supply terminal of the power amplifier 12, so that the power amplifier 12 stops operating.

In the protection circuit, the detection module detects the state control signal (the operation control signal or the standby control signal) outputted by the control assembly, and outputs the switch control signal according to the state control signal. The switch control module further controls switch-on and switch-off of the switch module according to the switch control signal, so that the power supply terminal of the power amplifier can selectively receive or not receive the supply voltage signal according to the state control signal, and supplies power to the power amplifier only when the aerosol generating device is in an operating state and stops supplying power to the power amplifier when the aerosol generating device is in a standby state. In this way, power consumption of the power amplifier is reduced. Compared with an operating manner in which the power amplifier is controlled according to a bias voltage of the power amplifier, because the switch module is connected to the power supply terminal of the power amplifier, and the control terminal of the power amplifier is connected to the constant-voltage signal, even if component variations and load variations induce fluctuations in the switch control signal, the bias voltage of the power amplifier remains unchanged (constant voltage), and the electrical performance of the power amplifier is still not affected. In addition, the constant-voltage signal is inputted to the control terminal of the power amplifier, the power amplifier is not frequently switched on and off, thereby reducing the risk of damage.

Further, in addition to the operation control signal and the standby control signal, the state control signal further includes an abnormality control signal. In this way, power supply to the power amplifier may be cut off when the device is in the standby state and an abnormal state, and power is supplied to the power amplifier only when the device is in a normal operating state (during user inhalation).

Further, the protection circuit of this disclosure further includes an anti-reverse module. The anti-reverse module is connected between the second terminal of the switch module and the power supply terminal of the power amplifier and is configured to prevent backflow of a microwave signal outputted by the power amplifier.

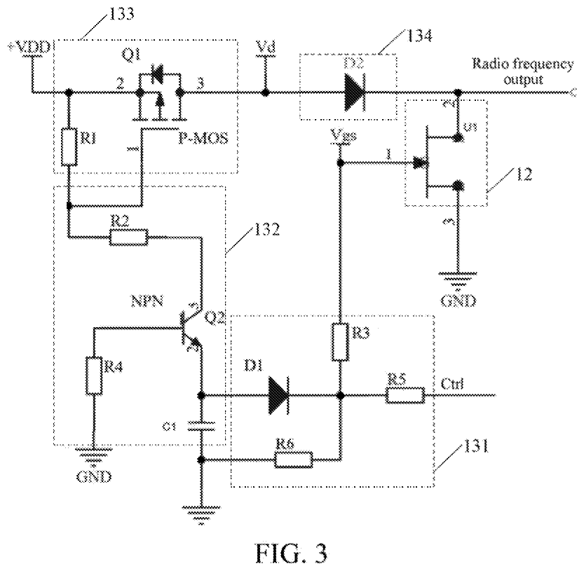

FIG. 3 is a circuit diagram of Example 2 of a power amplifier and a protection circuit in FIG. 1. The protection circuit is configured to protect the power amplifier 12. The power amplifier 12 includes a radio frequency amplifier transistor U1. A gate and a drain of the radio frequency amplifier transistor U1 are further respectively connected to components such as an inductor and a capacitor (not shown in the figure). The protection circuit of this example includes a detection module 131, a switch control module 132, a switch module 133, and an anti-reverse module 134.

The detection module 131 includes: a resistor R3, a resistor R5, a diode D1, and a resistor R6. A first terminal of the resistor R5 serves as an input terminal of the detection module 131 and is configured to input a state control signal (ctrl), and a second terminal of the resistor R5 is connected to a cathode of the diode D1 and a first terminal of the resistor R3. A negative voltage (Vgs) is connected to a second terminal of the resistor R3. An anode of the diode D1 serves as an output terminal of the detection module 131 and is configured to output the switch control signal. A first terminal of the resistor R6 is connected to the cathode of the diode D1, and a second terminal of the resistor R6 is connected to ground. In addition, the constant-voltage signal inputted via the control terminal of the power amplifier 12 is also a negative voltage. Therefore, the second terminal of the resistor R3 and the control terminal of the power amplifier 12 may be both connected to an output terminal of a negative voltage source. It should be understood that, the second terminal of the resistor R3 may be not connected to the control terminal of the power amplifier 12. For example, the second terminal of the resistor R3 and the control terminal of the power amplifier 12 are respectively connected to suitable voltage signals.

The switch module 133 includes: a metal-oxide-semiconductor (MOS) transistor Q1 and a resistor R1. The MOS transistor Q1 is a P-type MOS transistor. A source of the MOS transistor Q1 serves as the first terminal of the switch module 133 and is configured to input the supply voltage signal (+VDD), and a drain of the MOS transistor Q1 serves as the second terminal of the switch module 133 and is connected to the power supply terminal of the power amplifier 12 via the anti-reverse module 134. The resistor R1 is connected between the source and a gate of the MOS transistor Q1.

The switch control module 132 includes: a resistor R2, a resistor R4, a triode Q2, and a capacitor C1. A base of the triode Q2 is connected to ground via the resistor R4, and an emitter of the triode Q2 is connected to an output terminal of the detection module 131, that is, is connected to the anode of the diode D1. A collector of the triode Q2 is connected to the gate of the MOS transistor Q1 via the resistor R2. The capacitor C1 is connected between the emitter of the triode Q2 and ground.

The anti-reverse module 134 includes: a diode D2. An anode of the diode D2 is connected to the second terminal of the switch module 133, that is, is connected to the drain of the MOS transistor Q1, and a cathode of the diode D2 is connected to the power supply terminal of the power amplifier 12 and is configured to output a microwave signal.

An operating principle of the protection circuit is described below:

When the state control signal (ctrl) outputted by the control assembly is at a high level, for example, a high level is outputted when the aerosol generating device is in the standby state or the abnormal state, the diode D1 does not conduct, a base-emitter voltage of the triode Q2 is 0 V, and is less than an initial turn-on voltage, and the triode Q2 also does not conduct. In this case, the resistor R1 forces a gate-source voltage of the MOS transistor Q1 to be zero, the MOS transistor Q1 does not conduct, and a voltage at Vd is 0 V, and the power amplifier 12 cannot be powered on for operation.

When the state control signal (ctrl) outputted by the control assembly is at a low level, for example, a low level is outputted when the aerosol generating device is in the normal operating state, the diode D1 conducts, a base-emitter voltage of the triode Q2 is greater than the initial turn-on voltage, and the triode Q2 conducts, to pull a voltage at the collector of the triode Q2 down to ground. In this case, the supply voltage signal (+VDD) flows through the resistor R1 and the resistor R2 to GND. A gate-source voltage of the MOS transistor Q1 changes from 0 to a negative voltage. As a resistance between DS decreases toward 0, the MOS transistor Q1 conducts. A voltage appears at Vd, with a magnitude approximately equal to that of the supply voltage signal (+VDD). The voltage signal provides a voltage to the power amplifier 12 via the diode D2. It should be noted that the diode D2 may play a function of allowing unidirectional current flow, to prevent backflow of the alternating voltage and current of a radio frequency envelope signal when the power amplifier 12 is in an operating state, and prevent current backflow in the event of a power-down.

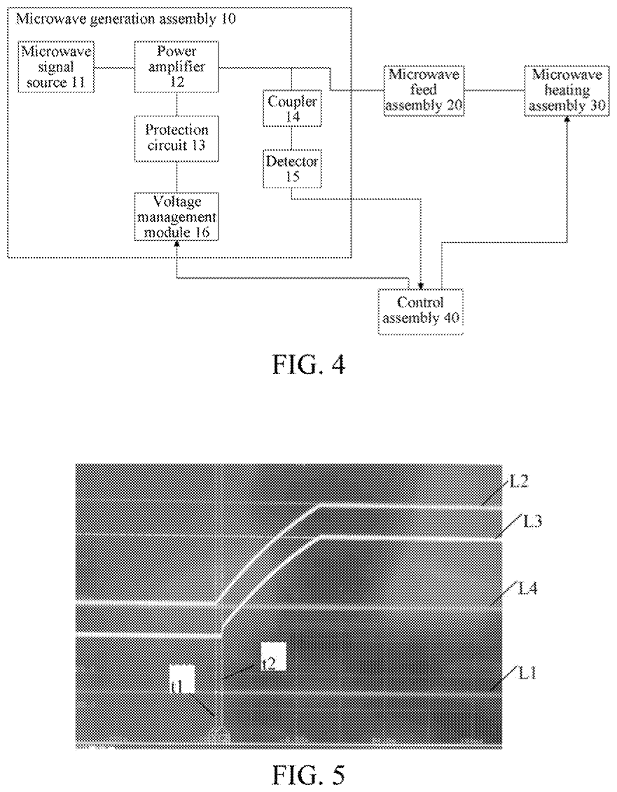

FIG. 4 is a logical structural diagram of Example 2 of an aerosol generating device of this disclosure. The only difference between the aerosol generating device and the aerosol generating device shown in FIG. 1 lies in that the microwave generation device 10 further includes a coupler 14, a detector 15, and a voltage management module 16. The coupler 14 is configured to couple a partial microwave signal of a microwave signal outputted by the power amplifier 12. The detector 15 is configured to detect an amplitude of the coupled microwave signal and transmit the amplitude to the control assembly 40. The control assembly 40 is further configured to adjust, according to the amplitude, the power of the microwave signal outputted by the power amplifier 12 by adjusting a supply voltage signal outputted by the voltage management module 16 to the power amplifier 12, for example, increase the power of the microwave signal outputted by the power amplifier 12 during user inhalation; or reduce the power of the microwave signal outputted by the power amplifier 12 when a user is not inhaling. The voltage management module 16 may not be set, and the control assembly 40 adjusts, according to the amplitude of the coupled microwave signal, the power of the microwave signal outputted by the power amplifier 12 in another manner, for example, adjusts the power of a microwave signal outputted by the microwave signal source 11.

The following describes a power-on sequence of signals in the aerosol generating device of this disclosure.

First, as shown in FIG. 5, in this case, the state control signal is at a low level, as indicated by a curve L4. A voltage (a Vgs bias voltage) at the control terminal of the power amplifier 12 remains in a normally-on state, and the voltage is a negative voltage, as indicated by a curve L1. In addition, the Vgs bias voltage is prioritized to turn on when the device is turned on or restarted after a power-down. When the device is turned on, for example, the device is turned on at time t1, a power supply assembly outputs a supply voltage signal +VDD, which is indicated by a curve L2. Moreover, under control of a switch control signal, the supply voltage signal enables a voltage signal at Vd to increase from 0 at time t2 and stabilize at a predetermined voltage (calculated as a supply voltage minus a drain-source voltage of the MOS transistor Q1), to supply power to the power amplifier 12, as indicated by a curve L3, thereby enabling the power amplifier to be turned on for operation. In addition, as shown in FIG. 5, the supply voltage +VDD lags behind the bias voltage by more than 150 ms, and the voltage at Vd lags behind the supply voltage +VDD by 6 ms.

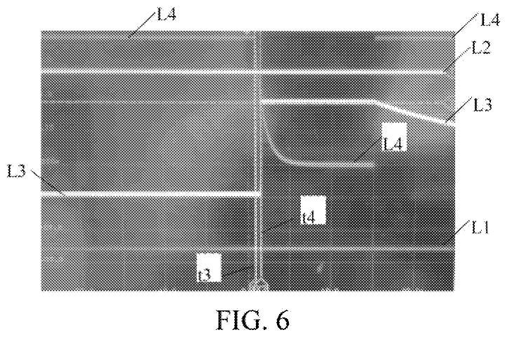

As shown in FIG. 6, in this case, the state control signal changes from a high level to a low level at time t3, as indicated by the curve L4. Moreover, when the state control signal is at a high level, because the switch module is turned off, and the power amplifier is in an off state, the voltage signal at Vd is 0, as indicated by the curve L3. When the state control signal changes to a low level, because the switch module conducts, under the control of the switch control signal, the supply voltage signal +VDD (as indicated by a curve L2) enables the voltage signal at Vd to increase from 0 at time t4, to the predetermined voltage (calculated as the supply voltage minus the drain-source voltage of the MOS transistor Q1), to supply power to the power amplifier 12, as indicated by the curve L3, thereby enabling the power amplifier to be turned on for operation. In addition, in this case, the voltage (the Vgs bias voltage) at the control terminal of the power amplifier 12 also remains in the normally-on state, and the voltage is a negative voltage, as indicated by the curve L1.

In conclusion, during turn-on, power-down, multiple operating modes, and sudden abnormalities of the aerosol generating device, the control terminal of the power amplifier maintains a stable constant voltage (a negative Vgs bias voltage), thereby ensuring stable performance of the power amplifier. In addition, the anti-reverse module allows unidirectional current flow, and isolates the front and rear stages of the power amplifier when the aerosol generating device is powered on for operation or powered off, and prevents the intrusion of voltage and current from the front or rear stages caused by radio frequency output or load variations, thereby avoiding damage to the power amplifier due to voltage fluctuations. In addition, during operation of the aerosol generating device, to improve reliability of the product and user experience, switch-on and switch-off of the power amplifier is controlled through logic control of the peripheral interface ctrl, thereby reducing power consumption of the product and satisfying the user experience. Therefore, the technical solutions of this disclosure can better provide protection to the power amplifier, so that operation of the power amplifier is stable and reliability of the device is improved.

It may be understood that the foregoing examples only describe preferred implementations of this disclosure specifically and in detail, but cannot be construed as a limitation on the patent scope of this disclosure. It should be pointed out that a person of ordinary skill in the art may further make several modifications and improvements without departing from the concept of this disclosure, and these modifications and improvements all fall within the scope of protection of this disclosure. Therefore, all equivalent changes and modifications made within the scope of the claims of this disclosure shall fall within the coverage of the claims of this disclosure.

What is claimed is:

1. An aerosol generating device comprising:
a microwave generation assembly including a microwave signal source, a power amplifier, and a protection circuit;
a microwave feed assembly;
a microwave heating assembly, the microwave feed assembly feeding a microwave signal generated by the microwave generation assembly to the microwave heating assembly for heating an aerosol generating substrate;
a control assembly being configured to determine a current state of the aerosol generating device, and output a state control signal, wherein the state control signal comprises an operation control signal and a standby control signal; and
wherein the protection circuit comprises:
a detection module, configured to detect the state control signal, and output a switch control signal according to the state control signal;
a switch module, wherein a supply voltage signal is inputted via a first terminal of the switch module, a second terminal of the switch module is connected to a power supply terminal of the power amplifier, and a constant-voltage signal is inputted via a control terminal of the power amplifier; and
a switch control module, configured to control switch-on and switch-off of the switch module according to the switch control signal.

2. The aerosol generating device of claim 1, wherein
the detection module includes a first resistor, a second resistor, and a first diode, wherein
a first terminal of the second resistor serves as an input terminal of the detection module and is configured to input the state control signal,
a second terminal of the second resistor is connected to a cathode of the first diode and a first terminal of the first resistor,
a negative voltage is connected to a second terminal of the first resistor, and an anode of the first diode serves as an output terminal of the detection module and is configured to output the switch control signal.

3. The aerosol generating device of claim 2, wherein
the control terminal of the power amplifier is further connected to an output terminal of a negative voltage source, and the second terminal of the first resistor is connected to the control terminal of the power amplifier.

4. The aerosol generating device of claim 2, wherein the detection module further comprises:
a third resistor, a first terminal of the third resistor is connected to the cathode of the first diode, and a second terminal of the third resistor is connected to a ground.

5. The aerosol generating device of claim 1, wherein
the switch module comprises a first metal-oxide-semiconductor (MOS) transistor and a fourth resistor R1,
a source of the first MOS transistor serves as the first terminal of the switch module and is configured to input the supply voltage signal,
a drain of the first MOS transistor serves as the second terminal of the switch module and is connected to the power supply terminal of the power amplifier, and
the fourth resistor is connected between the source and a gate of the first MOS transistor.

6. The aerosol generating device of claim 5, wherein
the switch control module comprises a fifth resistor, a sixth resistor, a triode, and a capacitor,
a base of the triode is connected to ground via the sixth resistor, an emitter of the triode is connected to an output terminal of the detection module, a collector of the triode is connected to the gate of the first MOS transistor via the fifth resistor, and the capacitor is connected between the emitter of the triode and the ground.

7. The aerosol generating device of claim 1, further comprising:
an anti-reverse module, between the second terminal of the switch module and the power supply terminal of the power amplifier, being configured to prevent backflow of a microwave signal outputted by the power amplifier.

8. The aerosol generating device of claim 7, wherein
the anti-reverse module comprises a second diode,
an anode of the second diode is connected to the second terminal of the switch module, and
a cathode of the second diode is connected to the power supply terminal of the power amplifier.

9. The aerosol generating device of claim 1, wherein the microwave generation assembly comprises:
a coupler is configured to couple a partial microwave signal of a microwave signal outputted by the power amplifier; and
a detector is configured to detect an amplitude of the coupled microwave signal and transmit the amplitude to the control assembly; and
the control assembly is configured to adjust, according to the amplitude, the power of the microwave signal outputted by the power amplifier.

10. The aerosol generating device of claim 9, wherein
the microwave generation assembly further comprises a voltage management module, and
the control assembly is configured to adjust, according to the amplitude, the power of the microwave signal outputted by the power amplifier by adjusting a supply voltage signal outputted by the voltage management module to the power amplifier.
